(19) United States
(12) Patent Application Publication
(10) Pub. No.: US 2016/0115020 A1
(43) Pub. Date: Apr. 28, 2016

(54) PROCESS AND PLANT FOR AT LEAST PARTIAL GASIFICATION OF SOLID ORGANIC FEED MATERIAL

(71) Applicant: LINDE AKTIENGESELLSCHAFT, München (DE)

(72) Inventors: Gerald Gaube, Dresdend (DE); Dirk Bauersfeld, Freiberg (DE)

(21) Appl. No.: 14/890,646

(22) PCT Filed: Apr. 30, 2014
(86) PCT No.: PCT/EP2014/001157

§ 371 Date: Nov. 12, 2015

(30) Foreign Application Priority Data
May 16, 2013 (DE) 10 2013 008 518.7

(51) Int. Cl. C01B 3/36; C10B 57/14; C10B 57/02; C10K 3/00

(52) U.S. Cl. CPC C01B 3/36; C10K 3/005; C10B 57/14; C10B 57/02; C01B 2203/025

(57) ABSTRACT

A process for at least partial gasification of solid organic feed material, in which a tar-containing low-temperature carbonization gas is obtained by low-temperature carbonization from the feed material in a low-temperature gasifier and the low-temperature carbonization gas is then converted to a synthesis gas in a high-temperature gasifier by partial oxidation and subsequent partial reduction. The low-temperature carbonization gas is admixed with a second gas. A plant equipped for carrying out the process includes a low-temperature gasifier for obtaining the low-temperature carbonization gas from the feed material, a high-temperature gasifier for obtaining synthesis gas from the low-temperature carbonization gas, and means for admixing the low-temperature carbonization gas with the second gas.

The present invention relates to a process and a plant for at least partial gasification of solid organic feed material, in particular biomass, having a low-temperature gasifier and a high-temperature gasifier.

### PRIOR ART

Processes for producing synthesis gas from solid organic feed material, also termed gasification processes for short, are known. Advantageously, as feed material for such processes, coal or biomass are used. In the case of biomass gasification processes, for example wood waste and forestry residues or what are termed wood fuels, but also agricultural residues such as straw or chaff are used.

By gasifying biomass to form synthesis gas with downstream process steps (termed biomass-to-liquids (BTL) processes), for example synthetic biofuel can be obtained which is similar in its physicochemical properties to known gas-to-liquids (GTL) and coal-to-liquids (CTL) fuels. An example of a plant for producing BTL fuels is shown in Kiener, C. and Bilas, J.: Synthetischer Biokraftstoff der zweiten Generation. Weltweit erste kommerzielle BTL-Produktionsanlage [Second-Generation Synthetic Biofuel. First commercial BTL production plant worldwide], Energy 2.0, July 2008, pp. 42-44.

Processes and plants for at least partial gasification of solid organic feed material are also known, for example, from EP 0 745 114 B1, DE 41 39 512 A1 and DE 42 09 549 A1. The present application in this case relates to those processes or plants which have a low-temperature gasifier and a high-temperature gasifier, as explained hereinafter. In comparison with other processes, said processes and plants permit, inter alia, a lower consumption of feed material and have a higher cold gas efficiency.

In a low-temperature gasifier, the feed material, for example biomass, is converted by partial gasification with a gasification means at temperatures of between approximately 300° C. and 600° C. to form coke (in the case of biomass termed biocoke) and low temperature carbonization gas. The conversion is termed, in the context of this application, “low-temperature carbonization”. Low-temperature carbonization is distinguished, as is known, by a sub-stoichiometric oxygen supply and therefore an incomplete combustion at a relatively low temperature.

The low-temperature carbonization gas is then transferred to a combustion chamber of the high-temperature gasifier and there partially oxidized with an oxygen-containing gas, for example with more or less pure oxygen, or else with air and/or oxygen-containing exhaust gases, e.g. from gas turbines or internal combustion engines. Heat liberated by this oxidation effects a temperature increase to 1200° C. to 2000° C., for example 1400° C. Under such conditions, aromatics, tars and oxo compounds present in the low-temperature carbonization gas are completely decomposed. As a result, a synthesis gas forms which substantially only further consists of carbon monoxide, hydrogen, carbon dioxide and steam. The synthesis gas at this point can also be termed as crude (synthesis) gas.

In a further stage, for example in a quench unit integrated in the high-temperature gasifier or connected downstream thereof, the synthesis gas thus produced is brought into contact with coke from the low-temperature gasifier. The coke can be treated separately (e.g. by milling and sifting) in advance and then introduced into the quench unit. Endothermic reactions between coke and synthesis gas cool the latter to about 900° C. This effects a partial conversion of the carbon dioxide to carbon monoxide.

The carbon monoxide-rich synthesis gas thus produced can then be further conditioned. The conditioning comprises, for example, a further cooling, a dedusting, a compression and/or separating of the residual carbon dioxide.

The low-temperature carbonization gas passed out from the low-temperature gasifier is tar-saturated, or virtually tar-saturated. Therefore, when the temperature of the low-temperature carbonization gas falls, the tar condenses and finally lines and containers become blocked. Corresponding plants are therefore maintenance-prone.

There is therefore the need for improvements in the operation of corresponding plants, in particular to avoid excessive tar deposits.

### DISCLOSURE OF THE INVENTION

According to the invention a process and a plant are proposed for at least partial gasification of solid organic feed material, in particular biomass, having a low-temperature gasifier and a high-temperature gasifier with the features of the independent claims. Preferred embodiments are subject matter of the subclaims and the following description.

### ADVANTAGES OF THE INVENTION

The invention proceeds from a known process for at least partial gasification of solid organic feed material, for example biomass. A tar-containing low-temperature carbonization gas is obtained by low-temperature carbonization from the feed material in a low-temperature gasifier, as explained hereinbefore. The low-temperature carbonization gas is then converted to a synthesis gas in a high-temperature gasifier by partial oxidation and subsequent partial reduction.

According to the invention, it has been found that the disadvantages explained at the outset can be overcome by admixing the low-temperature carbonization gas with a fraction of the synthesis gas obtained and/or of a gas mixture derived therefrom. The gas mixture derived from the synthesis gas can be, for example, a conditioned synthesis gas, for example a synthesis gas that is dedusted, cooled, compressed and/or freed from carbon dioxide.

Owing to the admixing of the low-temperature carbonization gas with the fraction of the synthesis gas and/or of the gas mixture derived therefrom, that is to say the admixing of a tar-saturated gas mixture with a substantially tar-free gas mixture, the tar partial pressure is lowered, as a result of which tar condensation with decreasing temperature is reliably prevented. The plants operated correspondingly are therefore much less maintenance-prone, because the lines do not become blocked with tar, or only scarcely become blocked with tar.

“Tar”, in the context of this application, is taken to means brownish to black, viscous mixture of organic compounds which are formed by destructive thermal treatment (pyrolysis) of organic natural materials such as the described low-temperature carbonization. For further properties of tars, cf. Neumüller O.-A. (Editor): Römpp's Chemie-Lexikon. 8^{th} Edition Stuttgart: Franckh'sche Verlagshandlung, 1983, p. 4137 and Blümer, G.-P., Collin, G. and Höke, H.: Tar and Pitch. In: Ullmann's Encyclopedia of Industrial Chemistry, 5^{th} Edition Weinheim: VCH, 1988. vol. A26, pp. 91-128. “Coke” is correspondingly the residues remaining after the low-temperature carbonization.

A further advantageous effect of the measures according to the invention is the stabilization of the start-up, shut-down, partial load and standard operation of a corresponding plant, because in particular unwanted backflows are prevented. This stabilization evens out process-related fluctuations and thus permits a more stable operation. The admixing of the fraction of the synthesis gas and/or of the gas mixture derived therefrom with the low-temperature carbonization gas generates a pressure drop that prevents the backflow of corresponding gases. Overall a stabilization is effected of the flow conditions in the gasifiers and also in the inflow and outflow pipelines in all operating states.

The recycle proposed according to the invention of the synthesis gas to the low-temperature gasifier in addition permits the start-up of the low-temperature gasifier and of the high-temperature gasifier under reducing conditions. The high-temperature gasifiers used in corresponding plants have what are termed start-up burners for commissioning. These can be operated under reducing conditions during commissioning. The resultant synthesis gas is recirculated via the recycle to the low-temperature gasifier and used for warming up the low-temperature gasifier until the ignition temperature thereof is reached.

The measures proposed according to the invention also effect a markedly more stable operation of the burners used in this case, since the flow conditions remain constant under load changes.

The admixing of the low-temperature carbonization gas with the fraction of the synthesis gas and/or of the gas mixture derived therefrom can be performed either by feeding in the fraction of the synthesis gas and/or the gas mixture derived therefrom into the low-temperature gasifier and/or by feeding in downstream of the low-temperature gasifier, that is to say between low-temperature gasifier and high-temperature gasifier. Both alternatives can also be advantageous. For example, a substream can be fed into the low-temperature gasifier and a further substream into a line between the low-temperature gasifier and the high-temperature gasifier.

As explained, by the process according to the invention, in particular, a tar partial pressure in the low-temperature carbonization gas can be decreased. Advantageously, therefore, the fraction of the synthesis gas and/or of the gas mixture derived therefrom which is used for admixing with the low-temperature carbonization gas can be established at least on the basis of a tar content and/or of a temperature difference of the low-temperature carbonization gas. For example, in the case of low-temperature carbonization gases of low tar content, a smaller fraction of the synthesis gas and/or of the gas mixture derived thereof gas can be used. Also, smaller fractions of corresponding gas mixtures can be used, when lower temperature differences are to be expected.

In the context of the process according to the invention, the low-temperature carbonization gas in the low-temperature gasifier is obtained from the feed material by low-temperature carbonization at 300° C. to 600° C. Low-temperature carbonization gases correspondingly obtained are generally tar-saturated, in such a manner that admixing with the fraction of the synthesis gas and/or of the gas mixture derived therefrom is particularly advantageous.

The partial oxidation of the low-temperature carbonization gas in the high-temperature gasifier by means of an oxygen-containing gas leads to heating of the gas to about 1,400° C. to 2,000° C. The oxygen-containing gas can be, as explained above, more or less pure oxygen, air and/or oxygen-containing exhaust gases of known processes.

An increase in the cold gas efficiency advantageously proceeds by feeding in coke that is obtained from the feed material in the low-temperature gasifier, whereby cooling to 800° C. to 1,000° C. proceeds.

As likewise explained, the synthesis gas is conditioned, that is to say is, for example, cooled, dedusted, compressed and/or freed from carbon dioxide, in each case obtaining a gas mixture derived from the synthesis gas, in such a manner that it is suitable for a subsequent synthesis, for example a Fischer-Tropsch process.

Advantageously, a pressure drop is established at least between the low-temperature gasifier and the high-temperature gasifier. This pressure drop contributes to avoiding backflows which are caused, for example, by process faults. In the case of multipart gasification processes, such process faults can lead to problems in conventional plants. For this purpose, for example, between the low-temperature gasifier and the high-temperature gasifier, or between further appliances, a pressure drop is generated by means of suitable piping components and/or pipelines having high flow velocities.

The plant likewise provided according to the invention is equipped for carrying out a process as has been explained above. It has a low-temperature gasifier in which a tar-containing low-temperature carbonization gas can be obtained by low-temperature carbonization from a solid organic feed material, and a high-temperature gasifier in which the low-temperature carbonization gas can be converted partial oxidation and subsequent partial reduction to form a synthesis gas by.

The plant further comprises means which are equipped for admixing the low-temperature carbonization gas with a fraction of the synthesis gas and/or of a gas mixture derived therefrom. Such means can have, for example, pipe systems having one or more return lines and suitable open-loop and/or closed-loop control appliances.

The plant according to the invention profits, in the respective embodiments thereof from the advantages explained hereinbefore and cited hereinafter, in a similar manner, in such a manner that reference may be explicitly made thereto.

In particular, a corresponding plant also has means which are equipped to establish a pressure drop at least between the low-temperature gasifier and the high-temperature gasifier.

The invention will be explained further with reference to the accompanying figures, which show preferred embodiments of the invention.

### BRIEF DESCRIPTION OF THE DRAWINGS

FIG. 1 shows a plant which is equipped for carrying out a process according to the invention, in a schematic presentation.

FIG. 2 shows a process according to the invention in the form of a flow chart.

### EMBODIMENT OF THE INVENTION

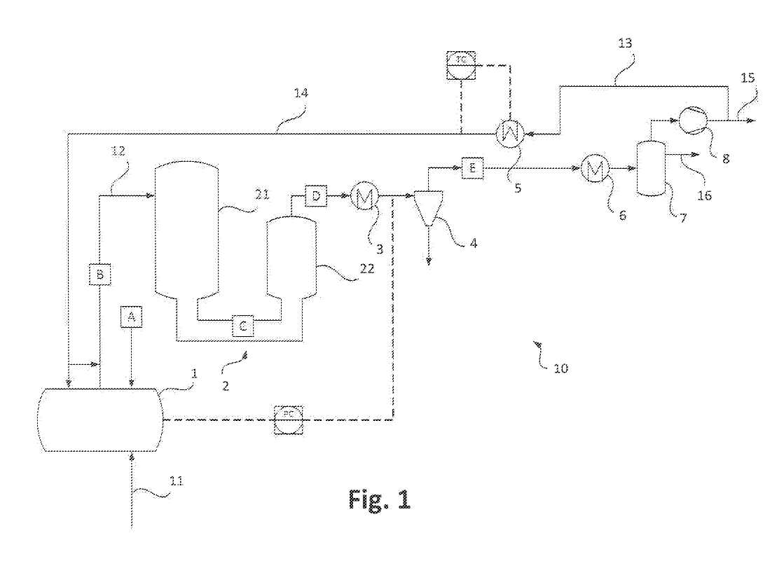

In FIG. 1 a plant is shown which is equipped for carrying out a process according to the invention and is designated overall as 10. The plant 10 comprises a low-temperature gasifier 1 and a high-temperature gasifier 2.

A feed material A, for example biomass such as wood, or corresponding wastes, as explained above, can be fed into the low-temperature gasifier 1. Via a line 11, oxygen, for example, can be fed in. The low-temperature gasifier 1 is equipped for low-temperature carbonization of the solid organic feed material A. For this purpose, the low-temperature gasifier 1 can be heated to a suitable temperature, for example 300° C. to 600° C., externally, for example with waste heat of the high-temperature gasifier 2. In a start-up phase of the plant, in this case, start-up burners of the high-temperature gasifier 2 can also be used.

Via a line 12, a low-temperature carbonization gas B can be passed out from the low-temperature gasifier 1 and transferred into the high-temperature gasifier 2. The high-temperature gasifier 2 is constructed in two parts. It comprises an oxidation unit 21 and a quench unit 22. In the oxidation unit 21, the low-temperature carbonization gas B is partially oxidized with an oxygen-containing gas fed, as a result of which, as explained, temperatures of for example 1,400° C. to 2,000° C. result. A synthesis gas that is designated C, is obtained as a result.

The synthesis gas C is transferred into the quench unit 22 via a fluid connection between the oxidation unit 21 and the quench unit 22. in the quench unit 22, for example milled coke from the low-temperature gasifier 1 is introduced (which is not shown). Owing to the endothermic reactions proceeding hereby, the gas temperature cools in a short time to approximately 900° C. and at least partial reduction occurs.

The resultant gas mixture D which is still designated (now carbon monoxide-rich) synthesis gas, is fed to a cooler 3 and is there cooled to a temperature of for example 600° C. The synthesis gas can then be dedusted in a cyclone 4. The dedusted synthesis gas E, in the context of this application, now termed “gas mixture derived from the synthesis gas”, now has a temperature of, for example, 500° C. and can be cooled in one of further coolers 5 and 6. It can then be fed, for example, to a carbon dioxide separation appliance 7.

Downstream of the carbon dioxide separation appliance 7, a gas mixture obtained therein can be compressed, for example in a compressor 8. At the exit of the compressor 8, a substream of the compressed gas mixture can be branched off via a line 13. The substream can also be used for cooling in the cooler 5. This is temperature-controlled, shown by a corresponding controller TC. A correspondingly obtained gas stream can be combined with further gas streams and introduced via a line 14 into the low-temperature gasifier. By this means, the low-temperature carbonization gas B is admixed with the corresponding gas stream, as a result of which, as explained, a tar partial pressure can he decreased.

Via lines 15 and 16, further gas streams can be conducted out of the plant 10. In order to ensure a sufficient pressure drop and therefore to avoid backflows, the plant 10, in addition, has a pressure controller PC with actuators that are not shown.

Although in FIG. 1 feeding into the low-temperature gasifier 1 is shown, the feeding can also proceed, for example, into the line 12 between the low-temperature gasifier and the high-temperature gasifier.

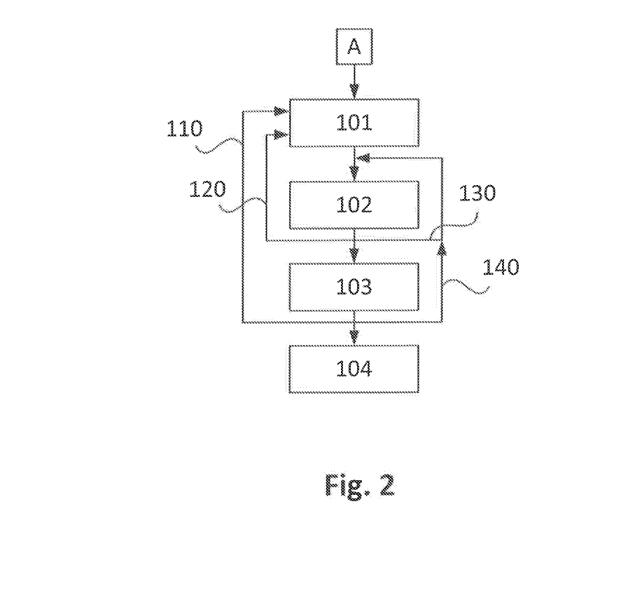

In FIG. 2, a process according to the invention according to a particularly preferred embodiment of the invention is shown schematically in the form of a flow chart and designated overall as 100.

In a first process step 101, an organic feed material A is converted at least in part to a low-temperature carbonization gas in a low-temperature gasifier, for example the low-temperature gasifier 1.

In a high-temperature gasifier, for example the high-temperature gasifier 2, the low-temperature carbonization gas B is then, as described, oxidized in a process step 102 and then reduced and thereby converted to a synthesis gas D.

A further process step 103 serves for treating (conditioning) the synthesis gas D, as explained above. As a result, as likewise explained, a treated gas mixture E is obtained which can be output at the plant boundary in a further process step 104.

According to a particularly preferred embodiment of the invention, it can be provided in each case to separate off a part of the synthesis gas D and/or a part of the gas mixture E prepared therefrom and to use it for admixing with the low-temperature carbonization gas B present in each case either in the process step 101, i.e. in the low-temperature gasification and/or between the low-temperature and high-temperature gasification, i.e. between steps 101 and 102. This is illustrated in each case by the arrows 110, 120, 130 and 140.

1. A process for at least partial gasification of solid organic feed material, in which a tar-containing low-temperature carbonization gas is obtained by low-temperature carbonization from the feed material in a low-temperature gasifier and the low-temperature carbonization gas is then converted to a synthesis gas in a high-temperature gasifier by partial oxidation and subsequent partial reduction, characterized in that the low-temperature carbonization gas is admixed with a second gas comprising a fraction of the synthesis gas, of a gas mixture derived from the synthesis gas, or a combination thereof.

2. The process as claimed in claim 1, in which the low-temperature carbonization gas is admixed with the second gas in the low-temperature gasifier or between the low-temperature gasifier and the high-temperature gasifier.

3. The process as claimed in claim 1, in which the second gas is established at least on the basis of a tar content or a temperature difference of the low-temperature carbonization gas.

4. The process as claimed in claim 1, in which the low-temperature carbonization gas in the low-temperature gasifier is obtained from the solid organic feed material by low-temperature carbonization at 300° C. to 600° C.

5. The process as claimed in claim 1, in which the partial oxidation of the low-temperature carbonization gas in the high-temperature gasifier is carried out by means of an oxygen-containing gas with heating to 1,400° C. to 2,000° C.

6. The process as claimed in claim 1, in which the partial reduction in the high-temperature gasifier is carried out by feeding in coke obtained from the feed material in the low-temperature gasifier and with a cooling to 800 to 1000° C.

7. The process as claimed in claim 1, in which the synthesis gas is cooled, dedusted, compressed and freed from carbon dioxide to obtain a gas mixture derived from the synthesis gas.

8. The process as claimed in claim 1, in which a pressure drop is established between the low-temperature gasifier and the high-temperature gasifier.

9. A plant having a low-temperature gasifier in which a tar-containing low-temperature carbonization gas can be obtained by low-temperature carbonization from a solid organic feed material and a high-temperature gasifier, in which the low-temperature carbonization gas can be converted by partial oxidation and subsequent partial reduction to form a synthesis gas, wherein means are provided for admixing the low-temperature carbonization gas with a fraction of the synthesis gas, a fraction of a gas mixture derived from the synthesis gas, or a combination thereof.

10. The plant as claimed in claim 9, in which means are provided to establish a pressure drop between the low-temperature gasifier and the high-temperature gasifier.
